(19) United States
(12) Patent Application Publication
(10) Pub. No.: US 2013/0340195 A1
(43) Pub. Date: Dec. 26, 2013

(54) WIPER BLADE ADAPTER DEVICE, IN PARTICULAR FOR A MOTOR VEHICLE WINDSCREEN WIPER DEVICE

(71) Applicants: Koen Bex, Jeuk/Limburg Belgien (BE); Helmut Depondt, Kessel-Lo (BE); Dirk Herinckx, Dries-Linter (BE)

(72) Inventors: Koen Bex, Jeuk/Limburg Belgien (BE); Helmut Depondt, Kessel-Lo (BE); Dirk Herinckx, Dries-Linter (BE)

(73) Assignee: ROBERT BOSCH GMBH, Stuttgart (DE)

(21) Appl. No.: 14/003,532

(22) PCT Filed: Jan. 12, 2012
(86) PCT No.: PCT/EP2012/050428

§ 371 Date: Sep. 6, 2013

(30) Foreign Application Priority Data
Mar. 7, 2011 (DE) 102011005171.6

(51) Int. Cl. B60S 1/40

(52) U.S. Cl. CPC B60S 1/40
USPC 15/250.32; 29/428

(57) ABSTRACT

The invention relates to a wiper blade adapter device, in particular for a motor vehicle windscreen wiper device, comprising a wiper blade adapter (10) which comprises at least one elastic latching means (12) for coupling to a wiper strip unit (14). According to the invention, said wiper blade adapter device comprises at least one securing means (16) which secures the at least one latching means (12) in a mounted state.

### BACKGROUND OF THE INVENTION

A wiper blade adapter device, in particular for a motor vehicle windscreen wiper device, comprising a wiper blade adapter which comprises at least one elastic latching means for coupling to a wiper strip unit is already known from the prior art.

### SUMMARY OF THE INVENTION

The invention relates to a wiper blade adapter device, in particular for a motor vehicle windscreen wiper device, comprising a wiper blade adapter which comprises at least one elastic latching means for coupling to a wiper strip unit.

According to the invention, the wiper blade adapter device comprises at least one securing means which secures the at least one latching means in a mounted state, whereby a particularly secure coupling of the wiper blade adapter to a wiper strip unit can be achieved. By the term “wiper blade adapter”, an adapter is particularly to be understood in this context which is provided to supply a coupling region of a wiper blade for coupling to a wiper arm adapter. By the term “latching means”, an elastic means for producing a latching connection is particularly to be understood in this context, which is intended to be elastically deflected during assembly. The at least one latching means is preferably connected in a positive locking manner to at least one component in a mounted state. The term “coupling” refers in this context particularly to a force-fit and/or positive-locking engagement. By the term “wiper strip unit”, a unit is particularly to be understood in this context which is provided to connect a wiper blade adapter to a wiper lip. The term “securing means” refers in this context particularly to a means which is provided to limit a latching means in the mobility thereof in the mounted state and/or to prevent an undesirable movement out of a locking position. The term “secures” refers in this context particularly to a limiting of at least a degree of freedom of a component, the degree of freedom serving to facilitate a movement of the component out of a locking position. By the term “locking position”, a position of a component is particularly to be understood in this context which said component assumes in an intended mounted state. The elastic components preferably have less spring tension in the locking position as in a deflected state. The term “provided” particularly refers to being specially designed and/or equipped.

In a further embodiment, it is proposed that the at least one securing means is intended to be elastically deflected out of a locking position when assembling the wiper blade adapter to the wiper strip unit. In so doing, the assembly process can be performed especially simply and quickly.

If the at least one latching means is movably mounted in one direction and the at least one securing means is movably mounted in another direction which is different from the first direction, the at least one latching means can be held in a locking position in a particularly secure manner. The latching means and/or the securing means can thereby be moved in a translational and/or preferably rotatory manner about a pivot axis.

It is further proposed that the at least one latching means can be deflected about a pivot axis which substantially runs parallel to a mounting direction. In so doing, an arrangement of the at least one latching means and or the deflection of the at least one latching means can be accommodated in a space-saving manner in the wiper blade adapter device. The term “pivot axis” particularly refers in this context to an imaginary axis about which a component can be deflected. The component can be pivoted via a hinge or advantageously via an elastically deformable section of the component. The term “substantially” refers in this context particularly to a deviation of less than 10°. By the term “mounting direction”, a direction is particularly to be understood in this context in which the wiper blade adapter moves during an assembly process for coupling to a wiper strip unit. In a mounted state, the mounting direction is preferably perpendicular to a surface to be wiped such as, for example, a motor vehicle window pane.

It is further proposed that the at least one securing means can be deflected about a pivot axis which runs substantially perpendicularly to a mounting direction of the wiper blade adapter. In so doing, a securing of the at least one latching means by the at least one securing means can be designed in a particularly stable and reliable manner.

In a further embodiment of the invention, it is proposed that the at least one latching means comprises a detent which is provided to produce a positive-locking connection to a wiper strip element of the wiper strip unit. In this context, said positive-locking connection preferably relates to a direct positive-locking connection in which the detent is in contact with the wiper strip element. A simple and cost-effective connection between the at least one latching means and the wiper strip element can thereby be achieved.

If the at least one securing means is embodied in one piece with the wiper blade adapter, the at least one securing means can be affixed to the wiper blade adapter in a particularly stable manner. By the term “embodied in one piece”, a materially bonded connection is to be particularly understood as, for example, by means of a welding process and/or adhesive bonding connection etc. In a particularly advantageous manner, “embodied in one piece” is to be understood as an integrally formed connection as by means of production from a mold and/or production in a single or multi-component injection molding process.

In a further embodiment of the invention, it is proposed that the at least one latching means is embodied in one piece with the wiper blade adapter, whereby the at least one latching means can be affixed to the wiper blade adapter in a particularly stable manner.

A method for mounting a wiper blade adapter of a wiper blade adapter device, the former comprising at least one latching means, to a wiper strip unit is further proposed, wherein the at least first latching means is secured by at least one securing means in the mounted state. In so doing, a particularly secure coupling of the wiper blade adapter to the wiper strip unit can be achieved.

Furthermore, according to the invention, the at least one latching means and the at least one securing means are deflected in different directions when the wiper blade adapter is being assembled to the wiper strip unit. As a result, assembly costs and/or assembly effort can be advantageously reduced.

### BRIEF DESCRIPTION OF THE DRAWINGS

Further advantages ensue from the following description of the drawings. An exemplary embodiment of the invention is depicted in the drawings. The drawings, the description and the claims contain numerous features in combination. The person skilled in the art will also expediently consider said features individually and put them together to form useful further combinations.

In the drawings:

FIG. 1 shows a perspective view of a wiper blade adapter device and a wiper strip unit.

FIG. 2 shows a perspective view of a wiper blade adapter device and a wiper strip unit in a first step of assembly.

FIG. 3 shows a perspective view of a wiper blade adapter device and a wiper strip unit in a further step of assembly.

FIG. 4 shows a perspective view of a wiper blade adapter device and a wiper strip unit in a further step of assembly.

FIG. 5 shows a perspective view of a wiper blade adapter device and a wiper strip unit in a further step of assembly.

FIG. 6 shows a perspective view of a wiper blade adapter device and a wiper strip unit in a further step of assembly.

FIG. 7 shows a perspective view of a wiper blade adapter device and a wiper strip unit in a further step of assembly.

FIG. 8 shows a perspective view of a wiper blade adapter device and a wiper strip unit in a further step of assembly and

FIG. 9 shows a partial cross section through the wiper blade adapter device in a mounted state.

### DETAILED DESCRIPTION

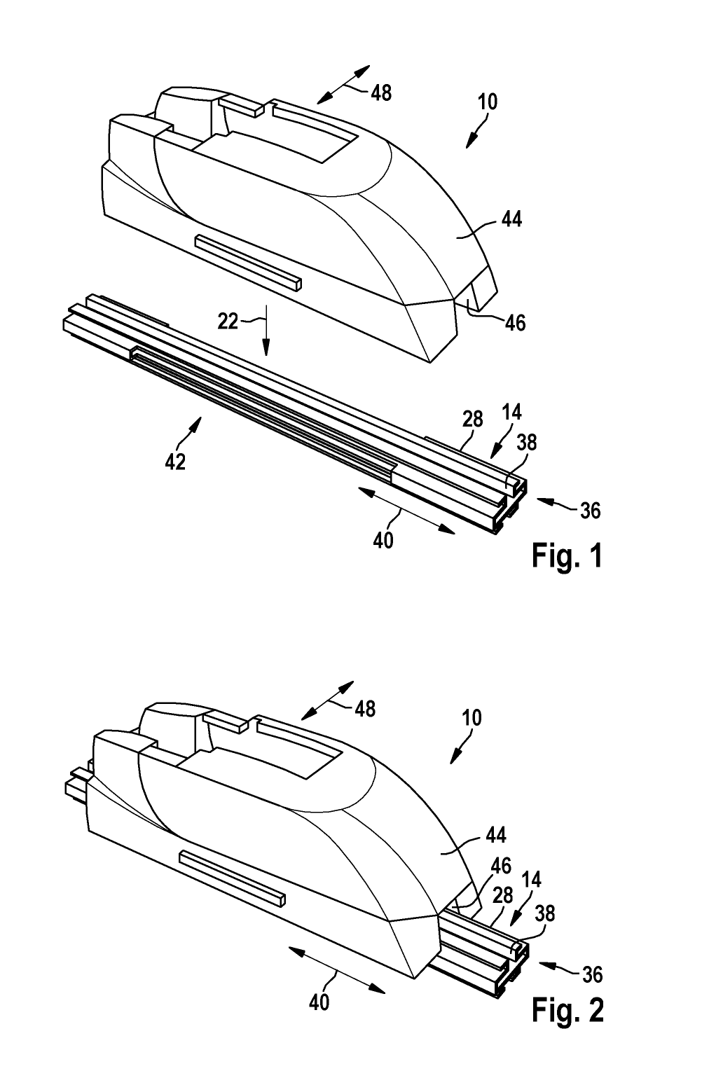

FIG. 1 shows a wiper blade adapter device for a motor vehicle windscreen wiper device. The wiper blade adapter device comprises a wiper blade adapter 10, which can be mounted to a wiper strip unit 14. The wiper strip unit 14 comprises an elongated wiper strip element 28, which has a longitudinal guide channel 36 for guiding a support element 26 (FIG. 5). The longitudinal guide channel 36 comprises a longitudinal opening 38 which extends in a longitudinal direction 40 of the wiper strip element 28 over the entire longitudinal guide channel 36.

The wiper strip element 28 is produced as one piece from a plastic material in an extrusion process. In this context, a person skilled in the art will consider different plastic materials which appear useful, such as in particular polyethylene, polypropylene, polyamide, polyvinylchloride and/or polystyrene. The wiper strip element 28 further comprises a fixing recess 42 which, as viewed in the longitudinal direction 40, is centrally disposed. An exact positioning of the wiper blade adapter 10 is provided by the fixing recess 42. The support element 26 is produced from spring steel and is provided to form the wiper strip unit 14 in an elastically deflectable manner.

The wiper blade adapter 10 comprises a base body 44 having a mounting recess 46 which is provided to receive the wiper strip unit 14 during assembly. The wiper blade adapter 10 moves in a mounting direction during assembly. The mounting direction 22 is perpendicular to the longitudinal direction 40 of the wiper strip element 28.

FIG. 2 shows the wiper blade adapter device during the next step of assembly. The wiper blade adapter 10 is placed on the wiper strip unit 14 by a movement in the mounting direction. In so doing, the base body 44 of the wiper blade adapter 10 encompasses the wiper strip unit 14. Said wiper strip unit 14 is partially within the mounting recess 46. A movement of the wiper blade adapter 10 relative to the wiper strip unit 14 is prevented in the longitudinal direction 40.

The wiper blade adapter 10 further comprises an elastic latching means 12 for coupling to the wiper strip unit 14. During assembly, the latching means 12 is elastically deflected about a pivot axis 18. The pivot axis 18 runs parallel to the mounting direction 22 of the wiper blade adapter 10. The latching means 12 further comprises a detent 24 which produces a positive-locking connection with the support element 26 in a mounted state.

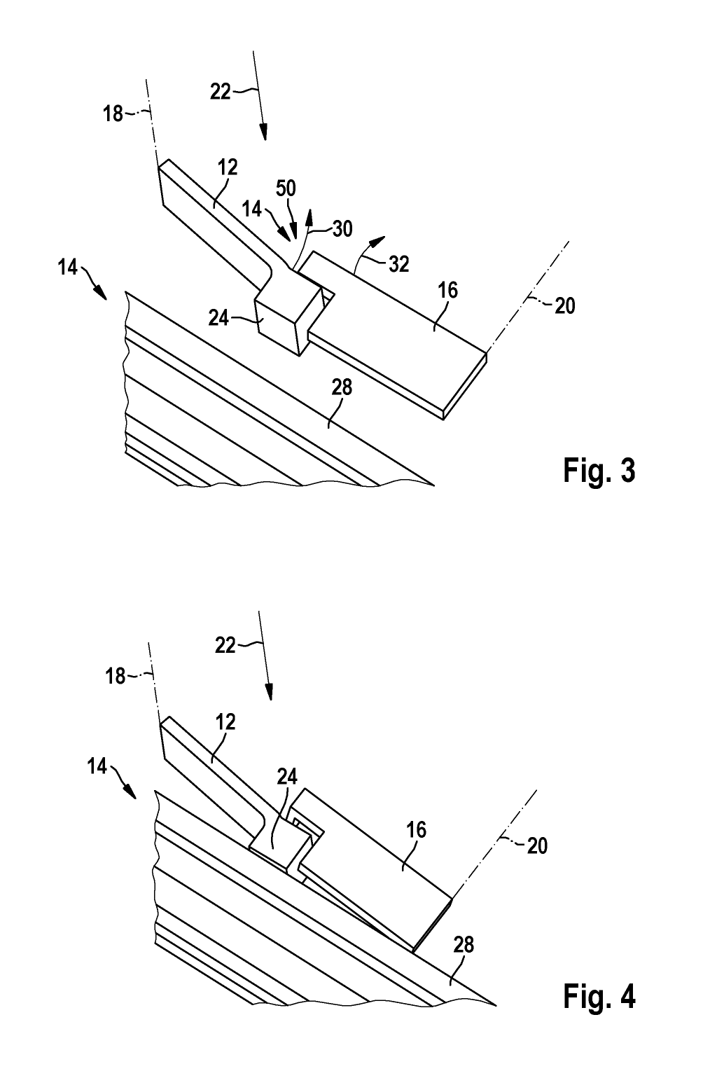

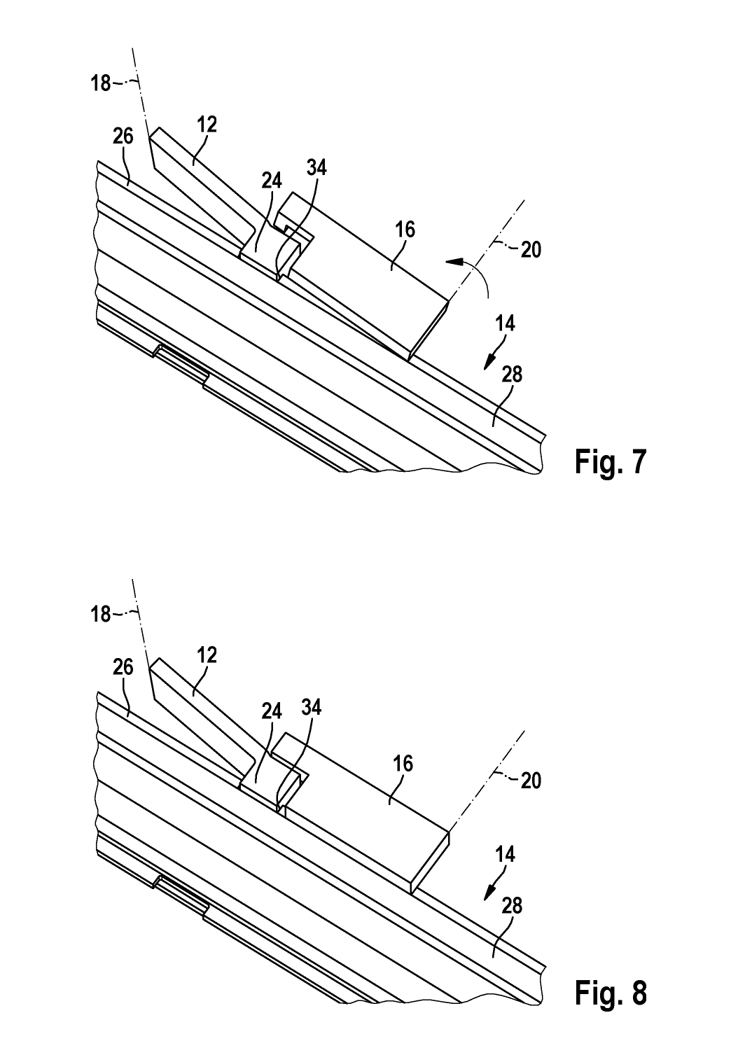

In addition, the wiper blade adapter device comprises an elastic securing means 16 which is embodied in one piece with the wiper blade adapter 10 and secures the latching means 12 in a mounted state. FIG. 3 shows the latching means 12 and the securing means in a perspective view prior to assembly to the wiper strip unit 14. For reasons of clarity, the wiper blade adapter 10 is not depicted in FIGS. 3 to 8 although said adapter is integrally formed with the latching means 12 and the securing means 16.

In the first step of assembly, as also shown in FIG. 1, the wiper blade adapter 10 is situated above the wiper strip unit 14. The latching means 12 and the securing means 16 are situated in a locking position (FIG. 3). The elastic latching means 12 and the elastic securing means 16 have less spring tension in the locking position as in a deflected state. The latching means 12 and the securing means 16 thereby rest against each other in a contact region 50.

The latching means 12 is movably mounted in a first direction 30. The securing means 16 is pivotably mounted in a further direction 32 that is different from the first direction 30. The first direction runs about the pivot axis 18. The further direction 32 runs about a further pivot axis 20 that extends perpendicularly to the mounting direction 22.

The pivot axis 20 encloses with the pivot axis 18 an angle of 90°. When mounting the wiper blade adapter 10 to the wiper strip unit 14, the latching means 12 and the securing means 16 are therefore elastically deflected out of the locking position in different directions 30, 32. A pivoting action of the latching means 12 about the pivot axis 18 is blocked by the securing means 16 in the locking position. It would however also be conceivable in this connection for a person skilled in the art to design the latching means 12 or the securing means 16 to be movable in a translatory manner.

When the wiper blade adapter 10 is being applied to the wiper strip unit 14, the securing means 16 is deflected about the pivot axis 20 (FIG. 4). The pivot axis 20 runs parallel to a wiping direction 48, in which the wiper blade adapter 10 and consequently the wiper strip unit 14 move in an operating state of the motor vehicle windscreen wiper device.

As a result of the securing means 16 being deflected, the latching means 12 is no longer secured, i.e. a rotation of the latching means 12 about the pivot axis 18 is possible counter to a spring force.

In a further step of assembly, the support element 26 is inserted into the longitudinal guide channel 36 of the wiper strip element 28 so as to be translationally parallel to the longitudinal direction 40 (FIG. 5). In so doing, the support element 26 presses against a locating face 54 of the detent 24 in an end region 52. The latching means 12 is thereby deflected against a spring force about the pivot axis 18 in a direction 30.

The locating face 54 encloses with the longitudinal direction 40 an obtuse angle. The locating face 54 is obliquely positioned relative to the direction of movement of the support element 26. A movement of the support element 26 parallel to the longitudinal direction 40 consequently brings about a movement of the detent 24 substantially transverse to the longitudinal direction 40.

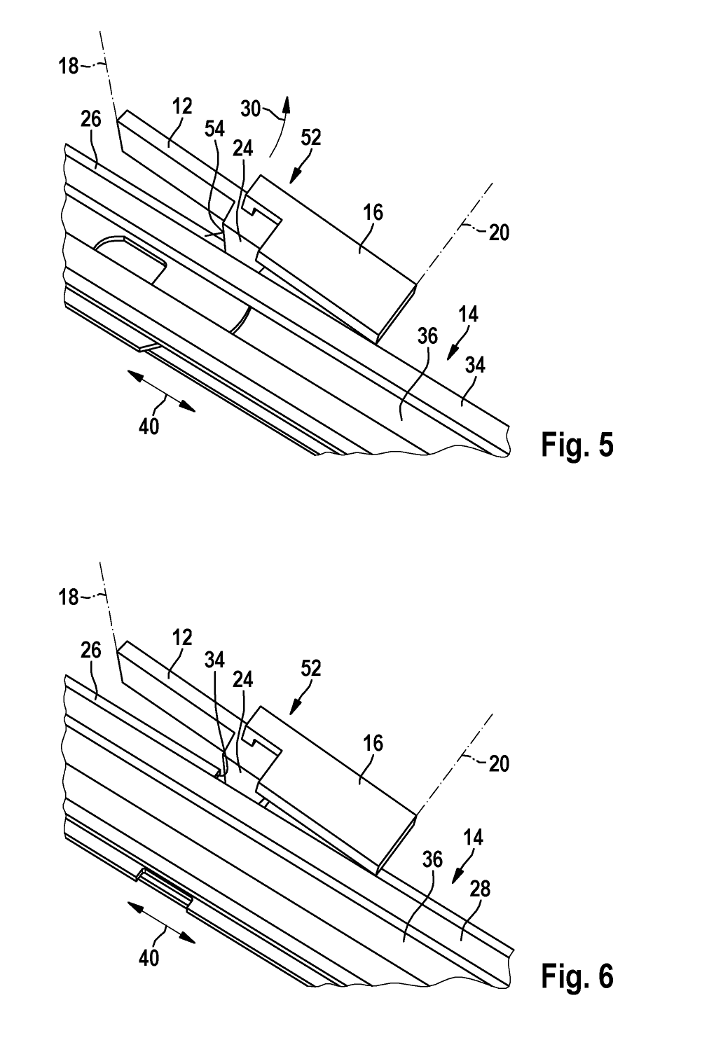

The support element 26 is now pushed at the deflected detent 24 further into the longitudinal guide channel 36. As viewed in the longitudinal direction 40, a detent recess 34 is centrally disposed in the support element 26. If the detent 24 moves over the detent recess 34, said detent 24 is pushed by means of the spring force of the latching means 12 into the detent recess 34 (FIG. 6). The detent recess 34 has a negative shape with respect to the detent 24; and therefore a precisely fitting positive-locking connection between support element 26 and detent 24 occurs within the detent recess 34.

If the detent is resting in the detent recess 34, the securing means 16 is no longer limited in the mobility thereof by the latching means 12 and moves elastically about the pivot axis 20. The securing means 16 is ultimately disposed behind the latching means 12 and lies flush against the same (FIG. 8).

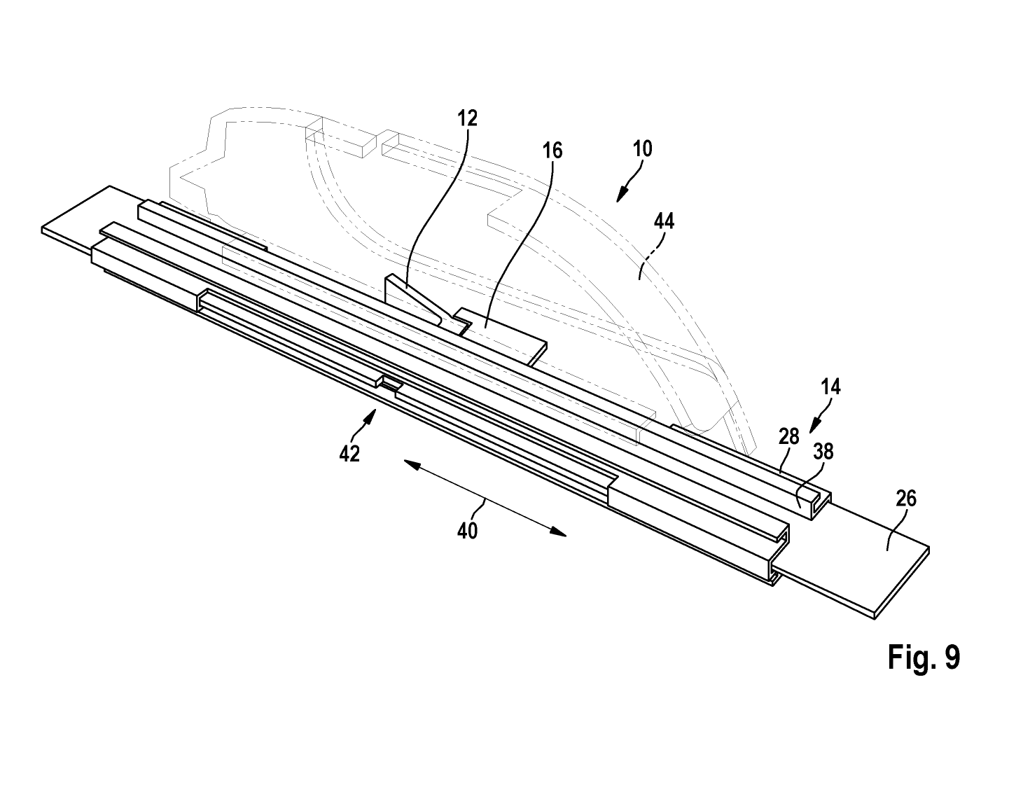

FIG. 9 shows a partial cross section of the wiper blade adapter device with the wiper strip unit 14 in a mounted state. The wiper blade adapter 10 is disposed within the fixing recess 42 of the wiper strip element 28. The latching means 12 and the securing means 16 are situated in the locking position. The detent 24 secures the support element 26 from displacing relative to the wiper strip element 28 in the longitudinal direction 40.

The securing means secures the latching means 12 from moving out of the locking position. It is also possible for a person skilled in the art to integrate further latching means and securing means into the wiper blade adapter device. In particular, a second latching means and a second securing means, which respectively are located opposite to the latching means 12 and the securing means 16, can be easily added to the present invention.

1. A wiper blade adapter device, comprising a wiper blade adapter (10) which comprises at least one elastic latching means (12) for coupling to a wiper strip unit (14), and at least one securing means (16) which secures the at least one latching means (12) in a mounted state.

2. The wiper blade adapter device according to claim 1, characterized in that the at least one securing means (16) is configured to elastically deflect out of a locking position when mounting the wiper blade adapter (10) to the wiper strip unit (14).

3. The wiper blade adapter device according to claim 1, characterized in that the at least one latching means (12) is movably mounted in a first direction (30) and the at least one securing means (16) is movably mounted in a further direction (32) which is different from the first direction (30).

4. The wiper blade adapter device according to claim 1, characterized in that the at least one latching means (12) is configured to be deflected about a pivot axis (18) which runs substantially parallel to a mounting direction (22) of the wiper blade adapter (10).

5. The wiper blade adapter device according to claim 1, characterized in that the at least one securing means (16) is configured to be deflected about a pivot axis (20) which runs substantially perpendicularly to a mounting direction (22) of the wiper blade adapter (10).

6. The wiper blade adapter device according to claim 1, in that the at least one latching means comprises a detent (24) which is provided to produce a positive-locking connection with a support element (26) of the wiper strip unit (14).

7. The wiper blade adapter device according to claim 1, characterized in that the at least one securing means (16) is embodied in one piece with the wiper blade adapter (10).

8. The wiper blade adapter device according to claim 1, characterized in that the at least one latching means (12) is embodied in one piece with the wiper blade adapter (10).

9. The wiper blade adapter device according to claim 1, characterized in that the at least one securing means (16) forms a positive-locking connection with the at least one latching means (12) in a mounted state.

10. A method for mounting a wiper blade adapter (10) of a wiper blade adapter device which comprises at least one elastic latching means (12) for coupling to a wiper strip unit (14), and at least one securing means (16) which secures the at least one latching means (12) in a mounted state, the method comprising securing the at least first latching means (12) by at least one securing means (16) in the mounted state.

11. The method according to claim 10, characterized in that the at least one latching means (12) and the at least one securing means (16) are deflected in different directions (30, 32) when mounting the wiper blade adapter (10) to a wiper strip unit (14).

12. A system comprising a wiper blade adapter (10) of a wiper blade adapter device according to claim 1, and also comprising a wiper strip unit (14) and a wiper strip element (28), wherein the at least one latching means (12) forms a positive-locking connection with the wiper strip element (28) in a mounted state and is secured by the at least one securing means (16).

13. The wiper blade adapter device according to claim 2, characterized in that the at least one latching means (12) is movably mounted in a first direction (30) and the at least one securing means (16) is movably mounted in a further direction (32) which is different from the first direction (30).

14. The wiper blade adapter device according to claim 13, characterized in that the at least one latching means (12) is configured to be deflected about a pivot axis (18) which runs substantially parallel to a mounting direction (22) of the wiper blade adapter (10).

15. The wiper blade adapter device according to claim 14, characterized in that the at least one securing means (16) is configured to be deflected about a pivot axis (20) which runs substantially perpendicularly to a mounting direction (22) of the wiper blade adapter (10).

16. The wiper blade adapter device according to claim 15, characterized in that the at least one latching means (12) comprises a detent (24) which is provided to produce a positive-locking connection with a support element (26) of the wiper strip unit (14).

17. The wiper blade adapter device according to claim 16, characterized in that the at least one securing means (16) is embodied in one piece with the wiper blade adapter (10).

18. The wiper blade adapter device according to claim 17, characterized in that the at least one latching means (12) is embodied in one piece with the wiper blade adapter (10).

19. The wiper blade adapter device according to claim 18, characterized in that the at least one securing means (16) forms a positive-locking connection with the at least one latching means (12) in a mounted state.
